(19) United States
(12) Patent Application Publication
(10) Pub. No.: US 2011/0289765 A1
(43) Pub. Date: Dec. 1, 2011

(54) METHOD AND DEVICE FOR PRODUCING A MULTI-LAYER COIL

(76) Inventors: Matthias Bohn, Petershagen (DE); Werner Krömmer, Landshut (DE)

(21) Appl. No.: 12/946,949

(22) Filed: Nov. 16, 2010

(30) Foreign Application Priority Data
Nov. 23, 2009 (DE) 10 2009 053 987.5
Mar. 16, 2010 (EP) 10 002 761.4

(51) Int. Cl. H01F 7/06

(52) U.S. Cl. 29/605; 29/729

(57) ABSTRACT

A method and device for producing a compact and/or massive multi-layer coil by means of dynamic cold spraying, electrically conductive connections are created between the individual conductor layers, which are embedded in the support material, in particular between the individual conductor tracks.

This application claims priority from German Patent Application 102009053987.5, filed Nov. 23, 2009 and European Patent Application 10002761.4, filed Mar. 16, 2010.

### BACKGROUND OF THE INVENTION

The instant invention relates to a method as well as a device for producing a multi-layer coil, wherein the method is based on cold gas spraying or dynamic cold spraying technology.

For coating at least one substrate or for producing at least one molded part, particulates in the non-melted state are hereby accelerated towards the surface of the substrate or the molded part, respectively, by means of at least one gas jet and stop there by converting their kinetic energy (see publication EP 1 382 720 A2 from the state of the art).

Accordingly, the device for coating the substrate or for producing the molded part encompasses at least one cold gas spray gun, wherein the cold gas spray gun and the substrate or molded part, respectively, which is to be coated, are arranged in a vacuum chamber (see publication EP 1 382 720 A2 from the state of the art).

Conventionally, conductors and coils, in particular superconductive coils, are first and foremost produced as wires, often in the form of a copper matrix comprising filaments of the superconductor.

On principle, materials are identified as being superconductive when their electric resistance drops to zero when they undershoot a certain critical temperature (material-dependent critical temperature, wherein the phase transition into the superconducting state does not take place abruptly, but continuously) and when they displace external magnetic fields from their interior (so-called Meiβner and Ochsenfeld effect).

Niobium titanium (NbTi) or also niobium tantalum, for example, are to be mentioned hereby as important superconductive material. Specifically in the case of porous materials, in particular in the case of high-temperature superconductor materials (so-called HTSL materials), the production takes place in complex sintering processes.

Subsequently, the wires produced in such a manner are wound to form coils, mostly on coil bodies, which serve to stabilize the coil. In addition, the wires can also be molded, mainly into synthetic resins. This molding into synthetic resins serves the purpose of completely stabilizing the coils, so that the coils withstand the high forces acting in the magnetic field, which is created in a superconductive manner; such high forces act in particular in devices for magnetic resonance tomography and in devices for nuclear magnetic resonance spectroscopy (NMR).

In the event that individual coil parts are not fixed sufficiently, the occurring micro-movements then lead to the collapse of the superconductivity (so-called quench, in the case of which the superconductor suddenly transfers from the superconductive state into the normal-conductive state, wherein a great deal of heat is created; the quench is particularly dangerous in the case of superconductive coils, because all of the field energy is converted into heat there in response to the collapse of the superconductivity.

Publication DE 38 06 177 A1 from the state of the art discloses the use of ceramic powder comprising superconductive characteristics as base material for the application of high-temperature superconductor material onto workpieces by means of thermal spraying; the superconductive characteristics are regenerated after the spraying by means of a specific heat treatment.

According to this publication DE 38 06 177 A1, the ampacity of the high-temperature superconductor layers is improved in that the thermal spraying takes place under conditions, in the case of which the particulates in the spray jet have a low intrinsic temperature and a high speed, whereby a high deformation is caused when they strike the substrate; the subsequent heat treatment takes place such that a grain growth of the crystallites in the layer is attained as a function of the degree of deformation.

Publication WO 2006/061384 A1 from the state of the art describes a method for cold gas spraying, in the case of which a gas jet, into which particulates are introduced, is generated by means of a cold spray gun. The kinetic energy of the particulates leads to a layer formation on a substrate, which encompasses a structure texture, which is transferred to the layer, which is forming.

According to this publication WO 2006/061384 A1, a high-temperature superconductive layer can be generated on the substrate by means of a suitable composition of the particulates. In addition, this process can be supported in a subsequent heat treatment step by means of a heating device.

With reference to the technological background of the instant invention, attention is additionally called
to publication “Microstructural characteristics of cold-sprayed nanostructured WC—Co coatings” by R. S. Lima, J. Karthikeyan, C. M. Kay, J. Lindemann and C. C. Berndt, Preparation and Characterization, ELSEVIER Sequoia, NL, Thin Solid Films 2002, volume 416, No. 1-2, pages 129 to 135, as well as
to publications DE 10 2004 058 806 A1, EP 1 921 176 A2, U.S. Pat. No. 5,646,094, US 2002/0056473 A1, US 2004/0026030 A1, US 2004/0202797 A1, WO 01/86018 A2 and WO 2004/044672 A2.

In the event that a coil is to now be produced by means of dynamic cold spraying in a fully compact manner in a generally random form, that is, as a massive block, the problem of providing this coil with a plurality of conductor layers as well as of creating conductive connections between the individual layers arises.

This technical problem is not fully solved by means of publication DE 10 2008 024 504 A1 (corresponds to publication US 2009/0291851 A1, which was published after the instantly claimed priority date), according to which the particulate in the non-melted state is accelerated towards the surface of the substrate or molded part, respectively, by means of dynamic cold spraying for the purpose of coating a substrate or for the purpose of producing a molded part and adheres there by converting its kinetic energy, wherein the particulates encompass
at least partially electrically conductive, in particular superconductive, characteristic and
at least partially weakly electrically conductive or electrically insulating (=electrically non-conductive) characteristic.

### SUMMARY OF THE INVENTION

Based on the afore-presented disadvantages and inadequacies as well as by acknowledging the outlined state of the art, the instant invention is based on the object of further developing a method as well as a device of the afore-mentioned type such that a plurality of conductor layers is provided in the case of a compact and/or massive coil, which is produced by means of dynamic cold spraying, as well as that conductive connections between the individual conductor layers are created.

This object is solved by means of a method for producing a multi-layer coil comprising
a) support particulates, comprising at least partially electrically weakly conductive characteristics or electrically insulating characteristics, are sprayed onto the surface selected from the group consisting of at least one substrate and molded part by means of cold gas spraying at least area by area for embodying at least one support layer;
b) conductor particulates, comprising at least partially electrically conductive characteristics, are sprayed onto the support layer by means of cold gas spraying at least area by area for embodying at least one conductor layer;
c) the conductor layer is formed into at least one conductor track by means of mechanical processing;
d) the conductor track is embedded by spraying on further support particulates comprising at least one further support layer;
e) conductor particulates are sprayed onto the further support layer comprising at least one further conductor layer;
f) the further conductor layer is formed into at least one further conductor track by means of mechanical processing; and
g) at least one electrically conductive connection is provided in addition to the conductor track, or between at least two proximate conductor layers;
wherein steps d, e, f and g can be iterated repeatedly for providing further conductor layers and can take place in any succession for forming the further conductor layers into further conductor tracks.

This object is further solved by means of device for producing a multi-layer coil comprising at least one cold gas spray gun, which is arranged in at least one vacuum chamber and comprising at least one electrically weakly conductive or electrically insulating material by forming at least one support layer and at least one electrically conductive material can be applied to at least one surface selected from the group consisting of at least one substrate and at least one molded part by forming at least one compact block or at least one stable microstructure, wherein provision is made for mechanical processing means for forming the conductor layer into at least one further conductor track and for mechanical processing means for providing at least one electrically conductive connection between at least two of the conductor layers.

The instant invention is therefore based on a mechanical method for dynamic cold spraying by means of which multi-layer electric conductors, in particular rotationally symmetric coils, for example of electrically superconductive materials, can be produced.

By using the cold gas spray method, a wide selection of materials, thus non-conductors (also weak conductors) and electrical conductors (also superconductors, in particular H[igh]T[emperature]S[uper] Conductors) can be applied to a base material or to the substrate. Due to the high speeds of the sprayed particulates or of the sprayed particles, layers are created, the characteristics of which are equivalent to those of cast or rolled materials.

Instead of the production of a wire or of the winding of a coil, the entire structure of a coil, for example, is sprayed onto the coil support, thus a copper matrix, superconductor tracks and insulation material. Due to the corresponding form and/or due to the corresponding guiding of the support material, coils can be produced in any form and in a completely compact as well as stable manner, for example in the form of a stable block or in the form of a compact brick.

The instant invention now makes it possible hereby to provide for “windings” in a plurality of layers, that means, in particular
the actual “individual wires” from the sprayed conductor layer as well as
corresponding conductive connections between the individual layers in the case of multi-layer “windings”.

According to the invention, this is attained in that the conductive layer is brought into at least one coil-shaped conductor track by means of mechanical processing, for example my means of machining or by means of laser or the like. This coil-shaped conductor track is embedded by spraying on at least one further layer of the support material.

At least one further layer of the conductor is then provided by spraying on and by mechanical processing, for example in a machined manner, by means of laser or the like; finally, the electrically conductive connection between the two conductor layers is provided by means of a type of “tapping hole spray method”.

In so doing, the production of any multi-layer magnetic coils is made possible according to the cold spray method, wherein the afore-mentioned method steps can be repeated several times, in particular as often as required, so as to provide multi-layer coil bodies comprising electric contacting between the individual conductor layers.

In a preferred development of the instant invention, niobium titanium (NbTi) or also niobium tantalum is alternately sprayed with copper as material comprising a high resistance, in particular as insulation layer for forming the (super)conductor layers, in particular the HTS layers. In so doing, provision is made for a compact as well as stable superconductive coil.

A good mixing of the particulates or particles, which are integrated into the formed layer, is guaranteed within this layer, in particular in response to the use of nanoparticulates or nanoparticles as particulates or particles, which are to be grown onto the substrate or molded part, respectively; in so doing, the conductor layer as well as the insulation layer are in each case embodied so as to be particularly consistent and stable.

According to a practical embodiment of the instant invention, the substrate or molded part, respectively, encompasses a microstructure or microstructure texture, which corresponds at least approximately to the microstructure or microstructure texture of a high-temperature superconductor (HTS). In other words, this means that the structure or structure texture of the substrate or molded part, respectively, can be transferred to the adhering particulates or particles.

The coating or layer, which is formed from the particulates or particles located in the cold spray thus encompasses a microstructure or microstructure texture, which is determined by the microstructure of the substrate or molded part, respectively, on which the layer grows.

Even though the structured or textured substrate, respectively, is no longer available for the formation of layers in the case of a progressive layer design, the already applied particulates or particles encompass the desired microstructure or microstructure texture, so that they can also serve as substrate for further impinging particles, which in turn attain the desired microstructure or microstructure texture.

Provided that the microstructure or microstructure texture of the substrate or molded part, respectively, is not yet completely transferred onto the coating, this transfer can be concluded by means of at least one diffusion process, which can be started and/or supported by means of at least one heat treatment of the coated substrate or molded part, respectively, which can be provided in a practical manner.

The quality of the HTS layer, for example, can be improved advantageously through this, for the purpose of which provision can be made according to the device for at least one heating device for carrying out such a heat treatment after the application of the particulates. The superconductive characteristics, in particular the high-temperature superconductive characteristics, can therefore be regenerated after the spraying by means of a specific heat treatment.

In an advantageous embodiment of the instant invention, at least one reactive gas, in particular oxygen, which is integrated into the, in particular further, support layer and/or into the, in particular further, conductor layer, can be added to the gas jet. In so doing, the layer variety, which can be created, can be increased in a practical manner, because the possibility of supplying at least one reactive gas adds a further optional parameter to the impacting of the running process.

The instant invention furthermore relates to a multi-layer coil, which is embodied as a compact block or as a stable structure, which is provided according to the method according to the type specified above and/or by means of the device according to the type specified above.

Finally, the instant invention relates to a use of a method according to the type specified above and/or to at least one device according to the type specified above for producing
in particular superconductive rotors and/or stators, in particular for electric motors or
conductive, in particular superconductive, coils, in particular for M[agnetic]R[esonance]I[maging] devices or for N[uclear]M[agnetic]R[esonance] devices.

As a result, a simplified producibility as well as product characteristics of electric conductors and coils, in particular of superconductive coils, for example of high-temperature superconductive coils, which are improved as compared to the state of the art, are ensured. In the case of such coils, provision can be made by means of the method according to the instant invention as well as by means of the device according to the instant invention for a plurality of conductor layers and conductive connections can be created between the individual conductor layers.

### BRIEF DESCRIPTION OF THE DRAWINGS

As already discussed above, there are different possibilities for embodying and further developing the teaching of the instant invention in an advantageous manner. Further embodiments, features and advantages of the instant invention will be defined in more detail below by means of the exemplary embodiment illustrated in FIG. 1 to FIG. 3, among others.

FIG. 1 shows, in a schematic illustration, an exemplary embodiment for a device according to the instant invention, which operates according to the method according to the instant invention.

FIG. 2A to FIG. 2H show, in a schematic illustration (upper portion of FIG. 2A to FIG. 2D in perspective view, lower portion of FIG. 2A to FIG. 2D in a partial cross section; FIG. 2E to FIG. 2H in a partial cross section), an exemplary embodiment for the sequence of the steps of the method according to the instant invention.

FIG. 3 shows, in a schematic partial cross sectional illustration, an exemplary embodiment for a method product according to the instant invention, which is produced according to the instant invention.

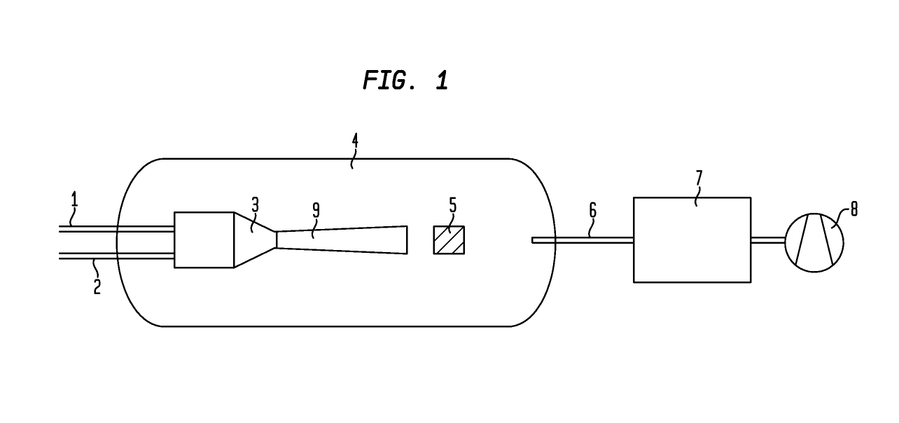

The same or similar embodiments, elements or features are provided with identical reference numerals in FIG. 1 to FIG. 3.

### DETAILED DESCRIPTION OF THE INVENTION

A device illustrated by means of FIG. 1, which is suitable for operating the method according to the invention, encompasses a vacuum chamber 4, in which a substrate 5 can be positioned upstream of the nozzle of a cold spray gun 3 (the positioning of the base material or substrate 5 upstream of the cold spray gun 3 takes place by means of a fastener, which is not shown in FIG. 1 only for the sake of clarity of the illustration).

For carrying out the coating of the workpiece or the production of the molded part 5, respectively, the vacuum chamber 4 is evacuated and a gas jet, into which particulates for coating the workpiece or for producing the molded part 5, respectively, are fed, is produced by means of a cold gas spray gun 3.

Here, the main gas flow, for example a helium-nitrogen mixture comprising approximately forty volume % of helium, reaches into the vacuum chamber 4 via the gas supply 1; in the auxiliary gas flow, the spray particles reach into the vacuum chamber 4 via the supply 2, with a pressure of approximately forty milibar prevailing in said vacuum chamber, and there into the cold spray gun 3. For this purpose, the supplies 1, 2 are introduced into the vacuum chamber 4, in which the cold spray gun 3 as well as the molded part 5 is located. The entire cold spray process thus takes place in the vacuum chamber 4.

The particulates are accelerated by means of the cold gas jet to the extent that an adhesion of the particulates on the surface of the substrate 5, which is to be coated, is attained by converting the kinetic energy of the particulates. The particulates can be heated additionally, wherein the heating thereof is limited such that the melting temperature of the particulates is not reached (this fact contributes to the name of the term cold gas spraying).

The support gas, which sprays out of the spray gun 3 together with the spray particulates in response to the cold gas spraying and which carries the spray particulates to the workpiece 5, reaches into the vacuum chamber 4 after the spraying process. The used support gas is removed from the vacuum chamber 4 by means of the vacuum pump 8 via the gas pipe 6. The particulate filter 7, which removes free spray particulates from the used support gas, so as to prevent in a reliable manner that the solid state particles damage the pump 8, is connected between the vacuum chamber 4 and the vacuum pump 8.

A wide selection of materials, thus electric non-conductors, electric weak conductors, electric conductors and also electric superconductors as well as electric high-temperature superconductors can be applied to the base material 5 by means of the cold gas spraying method, which is illustrated by means of FIG. 1. Layers, the characteristics of which are equal to those of cast or rolled materials, are created due to the high speed of the sprayed particles.

Instead of the production of a wire or the winding of a coil, according to FIG. 1 the entire structure of a coil can be sprayed onto the coil support 5, namely a copper matrix, superconductor tracks and insulation material. Coils can be produced in any form and in a completely compact as well as stable manner, for example in the form of a stable block or a compact brick, by the corresponding form and guiding of the support material 5.

In FIG. 1, copper can be sprayed as insulation material (comprising a relatively high resistance) alternately with niobium titanium (NbTi) or also niobium tantalum as superconductive material by forming a superconductive coil.

The quality of this superconductive coil, in particular of this high-temperature superconductive coil, can be increased by means of a heating device (not shown in FIG. 1 only for the sake of clarity of the illustration) for carrying out a heat treatment. The superconductive characteristics, in particular the high-temperature superconductive characteristics, can therefore be regenerated after the spraying by means of such a specific heat treatment.

According to the method, the arrangement illustrated in FIG. 1 is used in particular in response to the production of, for example superconductive rotors and stators of electric motors, as well as in particular in response to the production of, for example rotationally symmetric, coils for M[agnetic]R[esonance]I[maging] devices or for N[uclear]M[agnetic]R[esonance] devices.

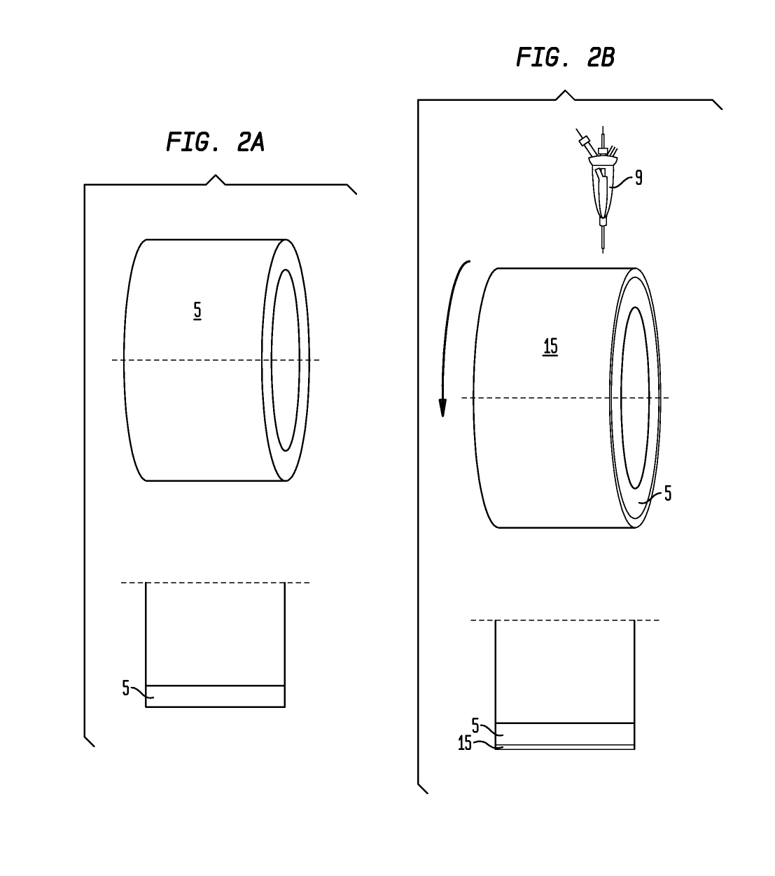

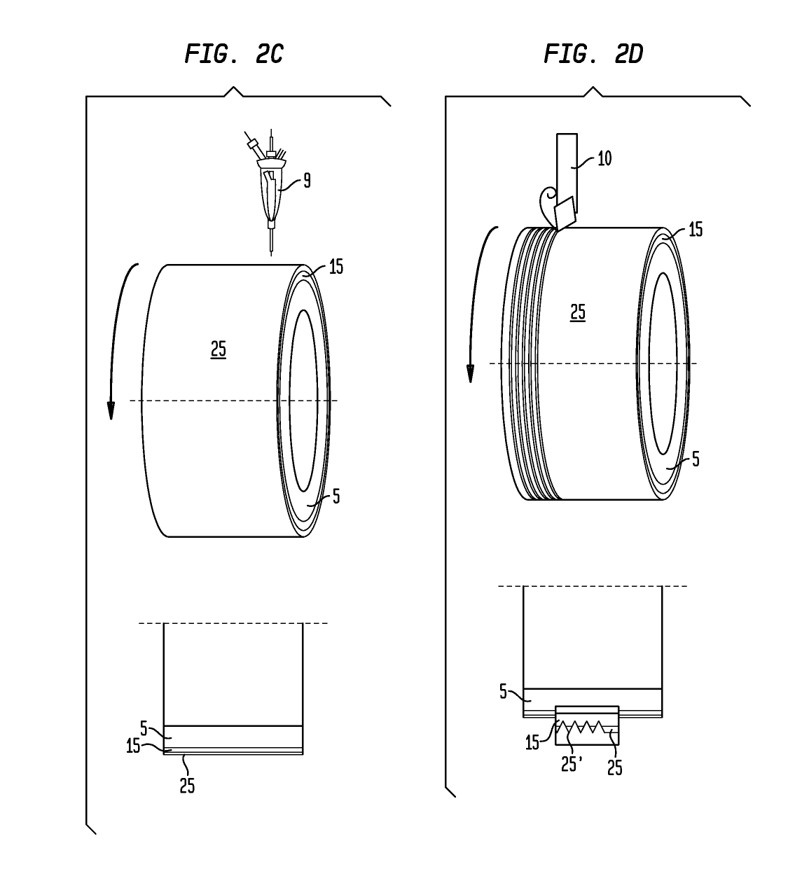

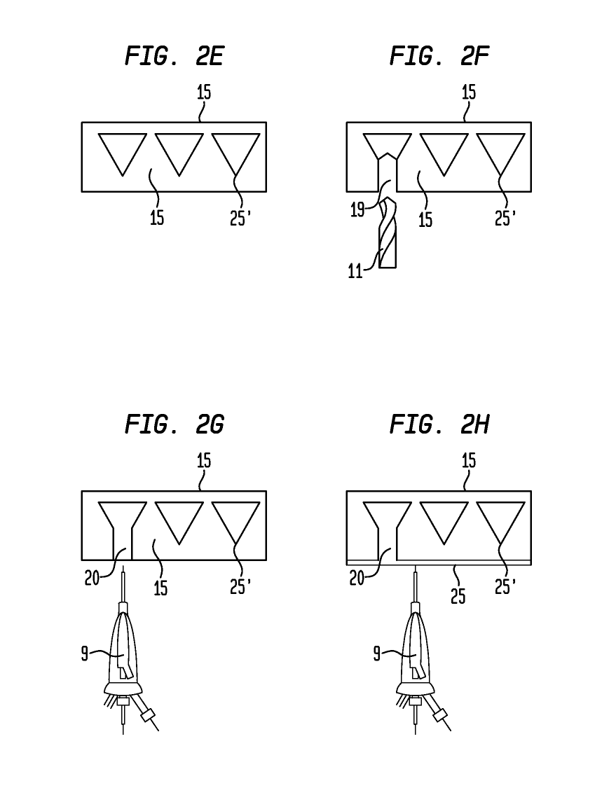

The sequence of the method steps according to the instant invention is explained by means of FIG. 2A to FIG. 2H:

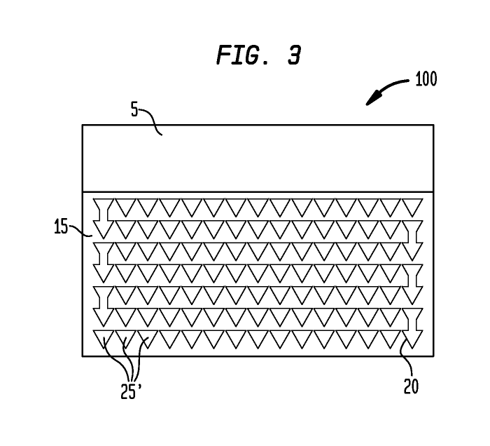

To produce a multi-layer coil 100, which is illustrated by means of FIG. 3, support particulates comprising weakly electrically conductive or electrically insulating (=electrically non-conductive) characteristics are sprayed on by means of cold gas spraying in the non-melted state (see FIG. 2B) for the purpose of coating the surface of a magnetic substrate, which acts as base material or magnetic molded part 5 (see FIG. 2A), which encompasses a microstructure or microstructure texture, which corresponds approximately to the microstructure or microstructure texture of a high-temperature superconductor (HTS).

The support particulates made of copper are hereby accelerated out of the nozzle 9 towards the surface of the substrate or molded part 5, respectively, by means of the gas jet created in the cold gas spray gun 3, then adhere at that location by converting their kinetic energy and thus form a support layer 15 in the form of a copper matrix.

Conductor particulates comprising electrically (high-temperature) superconductive characteristics in the non-melted state are then sprayed on by means of cold gas spraying for the purpose of coating the copper matrix 15 (see FIG. 2C). The conductor particle made of niobium titanium (NbTi) or of niobium tantalum are hereby accelerated out of the nozzle 9 towards the copper matrix 15 by means of the gas jet created in the cold gas spray gun 3, then adhere at that location by converting their kinetic energy and thus form a conductor layer 25.

The conductor layer 25 is formed into a coil-shaped conductor track 25′ by means of mechanical processing means 10, namely by means of machining (see FIG. 2D) or by means of laser. This method step thus causes a mechanic separation of the superconductive wires or conductor track within the conductor layer 25 through deflections or grooves located therebetween.

The conductor track 25′ effected by laser processing or deburring or machining is embedded by means of cold gas spraying of further support particulates while forming a further support layer 15 (see FIG. 2E).

An electrically superconductive connection 20 is provided to the conductor track 25′ in that, similar to a tapping hole spray method
a tapping hole-shaped or cylindrical recess 19 is introduced initially through the support layer 15, which adjoins the conductor layer 25, which is to be connected in an electrically conductive manner, by means of a drill 1 (see FIG. 2F) and
conductor particulates in the non-melted state are then sprayed from the nozzle 9 into the recess 19, so that the recess 19 is filled with electrically superconductive material by means of cold gas spraying while forming the connection 20 (see FIG. 2G).

After forming the electrically superconductive connection 20, the further support layer 15 together with the connection 20 is coated with conductor particulates while forming a further conductor layer 25 by means of cold gas spraying from the nozzle 9 (see FIG. 2H).

This further conductor layer 25 is also formed into a further coil-shaped conductor track 25′ by means of mechanical processing means 10, namely by means of laser or by means of machining (see FIG. 2D analogously). This method step thus causes an, in particular mechanical separation of the superconductive wires or conductor track within the further conductor layer 25 through deflections or grooves located therebetween, wherein this further conductor track 25′ is connected to the adjoining or proximate conductor track 25′ (for example located thereabove with reference to FIG. 3) in an electrically superconductive manner by means of the connection 20.

The sequence of method steps for providing further conductor layers 25 illustrated by means of FIG. 2D, FIG. 2E, FIG. 2F, FIG. 2G, FIG. 2H is repeated six times; the further conductor layers 25 are hereby in each case formed into further conductor tracks 25′, wherein the electrically superconductive connections 20 are alternatively generated on the opposite lateral edges of the further conductor tracks 25′, so as to thus provide for a constant electric connection between the innermost conductor track 25′ and the outermost conductor track 25′.

At the end of the production process is a rotationally symmetrical seven-layer coil 100 (see FIG. 3), which is embodied as compact block or as stable structure and which can be used
as superconductive rotor and/or stator for an electric motor or
as superconductive coil for a M[agnetic]R[esonance]I[maging] device or for N[uclear]M[agnetic]R[esonance] device.

### LIST OF REFERENCE NUMERALS

1 gas supply
2 supply
3 cold gas spray gun comprising nozzle 9
4 vacuum chamber
5 substrate, in particular magnetic substrate or molded part, in particular magnetic molded part, or base material, in particular magnetic base material
6 gas pipe
7 particulate filter
8 vacuum pump
9 nozzle of the cold gas spray gun 3
10 mechanical processing means, in particular machining means or laser
11 mechanical processing means, in particular drill
15 support layer, in particular further support layer, for example copper matrix, such as further copper matrix, for instance
19 recess, in particular tapped hole-shaped or cylindrical recess
20 electrically conductive, in particular electrically superconductive, connection
25 conductor layer, in particular further conductor layer
25′ conductor track, in particular further conductor track
100 multi-layer, in particular rotationally symmetric coil, for example multi-layer coil, which is embodied as compact block or as stable microstructure

What we claim is:

1. A method for producing a multi-layer coil, wherein
a) support particulates, comprising at least partially electrically weakly conductive characteristics or electrically insulating characteristics, are sprayed onto the surface selected from the group consisting of at least one substrate and molded part by means of cold gas spraying at least area by area for embodying at least one support layer;
b) conductor particulates, comprising at least partially electrically conductive characteristics, are sprayed onto the support layer by means of cold gas spraying at least area by area for embodying at least one conductor layer;
c) the conductor layer is formed into at least one conductor track by means of mechanical processing;
d) the conductor track is embedded by spraying on further support particulates comprising at least one further support layer;
e) conductor particulates are sprayed onto the further support layer comprising at least one further conductor layer;
f) the further conductor layer is formed into at least one further conductor track by means of mechanical processing; and
g) at least one electrically conductive connection is provided in addition to the conductor track, or between at least two proximate conductor layers;
wherein steps d, e, f and g can be iterated repeatedly for providing further conductor layers and can take place in any succession for forming the further conductor layers into further conductor tracks.

2. The method according to claim 1, characterized in that the electrically conductive connection comprises at least one recess which is provided mechanically in the support layer, which adjoins the conductor layer, which is to be connected in an electrically conductive manner and the recess is filled with electrically conductive material.

3. The method according to claim 1, characterized in that the electrically weakly conductive or electrically insulating characteristic is provided by copper and that the electrically conductive characteristic is provided by means of niobium titanium or by means of niobium tantalum, wherein the conductor particulates can at least partially include the chemical components of at least one high-temperature superconductor and the substrate or molded part can encompass a microstructure or microstructure texture, which corresponds at least approximately to the microstructure or microstructure texture of a high-temperature superconductor.

4. The method according to claim 1, characterized in that nanoparticulates or nanoparticles are used as support particulates and as conductor particulates.

5. The method according to claim 1, characterized in that at least one reactive gas which is integrated into the support layer and into the conductor layer, is added into the gas jet in response to the cold gas spraying.

6. The method according to claim 1, characterized in that at least one heat treatment of the coated substrate or molded part is carried out after the application of the support particulates and/or of the conductor particulates.

7. The method according to claim 1, characterized in that said conductor particulates are electrically superconductive.

8. The method according to claim 1, characterized in that said conductor layer is coil shaped.

9. The method according to claim 1, characterized in that said conductor layer and further conductor layer are formed into a conductor track by a mechanical process selected from the group consisting of machining or laser.

10. The method according to claim 1, characterized in that step (g) can be performed betweens steps (d) and (e).

11. The method according to claim 2, characterized in that a recess is drilled through the support layer.

12. The method according to claim 2, characterized in that the recess is filled with electrically superconductive material.

13. The method according to claim 5, characterized in that the reactive gas is oxygen.

14. A device for producing a multi-layer coil comprising at least one cold gas spray gun, which is arranged in at least one vacuum chamber and comprising at least one electrically weakly conductive or electrically insulating material by forming at least one support layer and at least one electrically conductive material can be applied to at least one surface selected from the group consisting of at least one substrate and at least one molded part by forming at least one compact block or at least one stable microstructure, wherein provision is made for mechanical processing means for forming the conductor layer into at least one further conductor track and for mechanical processing means for providing at least one electrically conductive connection between at least two of the conductor layers.

15. The device according to claim 14, characterized by at least one heating device for carrying out at least one heat treatment after applying the electrically weakly conductive or electrically insulating material and the electrically conductive material.

16. The device according to claim 14, characterized in that said multi-layer coil is a compact block or a stable structure.

17. The device according to claim 14, characterized in that a superconductive device selected from the group consisting of superconductive rotors, superconductive stators and superconductive coils is formed by operation of said device.

18. The device according to claim 14, characterized in that the electrically conductive connection comprises at least one recess which is provided mechanically in the support layer, which adjoins the conductor layer, which is to be connected in an electrically conductive manner and the recess is filled with electrically conductive material.

19. The device according to claim 14, characterized in that the electrically weakly conductive or electrically insulating characteristic is provided by copper and that the electrically conductive characteristic is provided by means of niobium titanium or by means of niobium tantalum, wherein the conductor particulates can at least partially include the chemical components of at least one high-temperature superconductor and the substrate or molded part can encompass a microstructure or microstructure texture, which corresponds at least approximately to the microstructure or microstructure texture of a high-temperature superconductor.

20. The device according to claim 14, characterized in that said conductor layer is coil shaped.

21. The device according to claim 14, characterized in that said conductor layer and further conductor layer are formed into a conductor track by a mechanical process selected from the group consisting of machining or laser.
